(19) United States
(12) Patent Application Publication
(10) Pub. No.: US 2009/0107410 A1
(43) Pub. Date: Apr. 30, 2009

(54) AQUARIUM COVER

(75) Inventors: Bruce G. Kania, Shepherd, MT (US); Frank M. Stewart, Bozeman, MT (US)

Correspondence Address: ANTOINETTE M. TEASE, P. O. BOX 51016, BILLINGS, MT, 59105, US

(73) Assignee: Fountainhead, LLC, Shepherd, MT (US)

(21) Appl. No.: 12/302,064

(22) PCT Filed: May 25, 2007
(86) PCT No.: PCT/US07/69714

§ 371 Date: Nov. 24, 2008

Related U.S. Application Data
(60) Provisional application No. 60/805,772, filed on Jun. 26, 2006.

(51) Int. Cl. A01K 63/00

(52) U.S. Cl. 119/246

(57) ABSTRACT

An apparatus and a method for covering an aquarium. In one embodiment, the invention is a cover for an aquarium comprising: a porous nonwoven matrix body comprising fibers; optional legs; and a plurality of plants growing in said porous nonwoven matrix body. In another embodiment, the invention is a cover for an aquarium comprising: a first porous nonwoven matrix member that is configured to produce an outer wall section and a second porous nonwoven matrix member that is configured to produce a bottom section that together form a pocket; a plant growth medium disposed within said pocket; and a fish feeding port. In yet another embodiment, the invention is a method comprising: providing a porous nonwoven matrix body comprising fibers, said porous nonwoven matrix body being configured to substantially cover an aquarium opening and being capable of accommodating the growth of plants; placing said porous nonwoven matrix body in said opening.

### CROSS-REFERENCE TO RELATED APPLICATION

This application claims priority back to U.S. Patent Application No. 60/805,772, filed on 26 Jun. 2006.

### BACKGROUND OF THE INVENTION

This invention relates to an aquarium cover. In particular, the invention relates to an aquarium cover that provides a plant habitat having a living, aesthetic appearance.

The background art is characterized by U.S. Pat. Nos. 5,224,292; 5,528,856; 5,766,474; 5,980,738; 6,086,755; and 6,555,219 and U.S. Patent Application Nos. 2003/0051398; 2003/0208954; 2005/0183331; the disclosures of which patents and patent applications are incorporated by reference as if fully set forth herein.

Aquariums range in size from small household fish tanks to large tanks used in public exhibits and commercial operations to display various species of aquatic and amphibious animals. Many aquariums, regardless of size, require a top protective cover. The purpose of these covers is to prevent fish and other animals from escaping, to exclude predators such as cats and birds from preying on the aquariums' inhabitants, to reduce excess light entry, and to provide aesthetic appeal. What is needed is an aquarium cover that serves the purposes described above, plus offers benefits that background art covers do not provide.

### BRIEF SUMMARY OF THE INVENTION

The purpose of a preferred embodiment of the invention is to provide an aquarium cover with a living, aesthetic appearance. In preferred embodiments, aquarium covers in accordance with the invention provide plant growing zones having a range of water saturation, from fully saturated to partially saturated (a vadose zone). This is useful for growing a range of plant types.

Preferred embodiments of the present invention are advantageous in that they serve as biological filters to remove excess concentrations of dissolved nutrients such as ammonia, nitrate, and phosphorus. In preferred embodiments, the present invention also filters out suspended solids and colloidal particles, thereby improving water quality. Moreover, in preferred embodiments, the present invention produces plant roots and can be used as a food source by animals in the aquarium. Furthermore, in preferred embodiments, the present invention is capable of growing plants, which have well-known benefits for humans, such as oxygen generation and dust control.

In some embodiments, the aquarium cover design is configured to maximize capillary action in order to enhance evaporation from the aquarium. This can be useful in environments where it is beneficial to humidify the air, for example, in houses with low humidity. In other embodiments, the aquarium cover is alternately designed to minimize evaporation from the aquarium in environments where low humidity is desirable, for example, in laboratories with sensitive electronic instruments.

In a preferred embodiment, the aquarium cover provides shade and cover to fish within the aquariums, thereby replicating their natural environment and encouraging natural behavior. The aquarium cover may also be used to grow food for humans, for example, arugula, spinach, alfalfa sprouts, and kale. Contaminants in the aquarium water are not transported through the plants; therefore, the plants are safe to eat.

In a preferred embodiment, the aquarium cover is designed so as to provide a terrarium surface for non-aquatic animals on top, with aquatic animals in the water below. The covers add to the diversity and complexity of the habitat and biological community. The covers provide a “cross section” view of root growth, which is interesting and educational.

In another preferred embodiment, the aquarium cover renders the aquarium habitat more holistic, by recycling and converting wastes into food for fish. Ammonia and phosphate that are produced by aquarium fish are excellent fertilizers for plants, and many plant roots are palatable to fish. The roots in turn provide a regulated food source for fish for when the owners are unable to provide daily food. The plant roots may be used to modify and enhance the colors of fish that eat the roots. For example, there are several commercial fish foods that are designed to enhance or modify fish coloration through the action of natural pigments mixed in the food. Similarly, plant roots that contain high concentrations of natural pigments such as carotene will have the ability to affect fish coloration if consumed by the fish.

In a preferred embodiment, the invention is an aquarium cover that comprises a porous nonwoven polymer fiber matrix that is positioned at the water surface of an aquarium, with a portion of the device below waterline and the remainder of the device above waterline. The polymer fiber matrix may be constructed from any suitable fiber such as polyester, polyethylene, or polypropylene, and may include binders such as baked-on latex adhesive. In this embodiment, the device serves as a biological and mechanical filter for the aquarium water, as well as a barrier to prevent fish escape and predator access. The matrix may be optionally combined with buoyant foam to provide floatation to the device. The buoyant foam may be comprised of either thermosetting or thermoplastic foam. An example of thermosetting foam is two-part polyurethane foam which is injected under pressure into the matrix, where it expands and chemically cures around the matrix fibers. An example of thermoplastic foam is polyethylene foam, which is extruded into the matrix with an expansion gas, after which it expands, cools and hardens around the matrix fibers. Buoyancy may also be provided by blocks of pre-cured foam that are inserted into precut holes within the matrix or that are mechanically bonded within or onto the matrix.

Terrestrial and/or aquatic plants may optionally be grown on the device. Sprayed-on polymer coatings may optionally be applied to selected portions of the top surface of the device. Accessories and cosmetic features such as a fish-activated fish feeder shaped like a miniature Ferris wheel may be installed on the top surface of the device.

Growing plants may optionally be integrated into the matrix of the device. Plants may be grown so that their roots and stems extend through the matrix. In preferred embodiments, the roots of aquatic plants grow into the aquarium water, and terrestrial and riparian plants grow with their roots in the “bi-vadose zone” of the device, above the zone of water saturation. In addition, if the aquarium water is sufficiently aerated, the roots of riparian and terrestrial plants may also grow down into the aquarium water and grow hydroponically.

Plants may also be grown in pockets that are formed within the matrix and filled with bedding soil or other growth medium such as peat and/or hydrophilic foam. In preferred embodiments, these pockets are particularly well suited to growing plants that prefer their roots to be above the water-saturated zone of the device. If the bottom of these pockets extends to waterline, then moisture may be supplied to roots growing above waterline within the pockets via capillary (or “wicking”) action up through the growth medium from the aquarium water below, if the growth medium is selected so as to provide wicking capability. Because the bi-vadose zone is preferably kept at a constant moisture level via capillary action, riparian plants that require constant moisture thrive in this environment.

In groundwater hydrology, the zones of the subsurface that contain water are split into the “saturated zone” and the unsaturated or “vadose zone.” The saturated zone is the area of the subsurface that lies at or below the water table. For example, when a well is drilled into the saturated zone, the level of standing water in the well is equivalent to the level of the water table.

The vadose zone is the portion of the subsurface that contains some water but is not saturated. The pore spaces between the soil or rock particles in the vadose zone contain a combination of water and air. Vadose zone water (or “vadose water”) is held in place by hydroscopic and capillary forces. The maximum amount of water that can be held in a particular vadose zone is a function of the particle size and shape of the soil or bedding medium or other materials within the zone, and of the gasses trapped within the zone. Excess water that enters the vadose zone (for example, from rainfall) normally drains by gravity through the vadose zone down to the saturated zone. Terrestrial plants have evolved to thrive in the vadose zone, as they require a growth medium in which their roots can uptake both water and air. Aquatic plants, in contrast, have evolved to thrive in the saturated zone; these plants do not need air-filled pore spaces around their roots. (Terrestrial plants can be grown hydroponically in the saturated zone, but they typically require supplemental aeration via mechanical aerators in order to obtain the required amount of oxygen).

In this disclosure, applicants use the term “saturated zone” to describe the portion of the matrix in which all of the pore spaces are filled with water. They use the term “bi-vadose zone” to describe the portion of the matrix in which the pore spaces are filled with a mixture of water and gases. The vadose zone in the present invention may be supplied by water from the top down, for example, by manual watering. In addition, the vadose zone may be supplied with water from the bottom up, via capillary action. Because this “bi-directional” water supply capability of the present invention is different from the “top-down only” water supply in conventional agricultural vadose zones, the applicants have coined the term “bi-vadose” zone to define the moist but unsaturated zone within the matrix or planted pocket. In preferred embodiments, the bi-vadose zone does not become saturated with water because any excess water that enters this zone drains down through the fibers by gravity or evaporates.

In preferred embodiments, the present invention provides a means for reducing harmful nutrient buildups such as buildups of ammonia and phosphate that are produced by fish and other animals within the aquarium. Both microbes and macrophyte plants may be incorporated into the invention to reduce the nutrient concentrations. The matrix fibers of preferred embodiments of the device provide an ideal growing area for beneficial microbes to colonize. These microbes may be naturally occurring, or they may be introduced into the system.

When nutrient-rich aquarium water comes into contact with the microbes, these microbes convert the nutrients to less toxic compounds; for example, ammonia is converted to nitrate by nitrifying bacteria, and phosphate is converted to organic phosphorus by the same organisms. The efficiency of the device for removing nutrients may be optionally increased by mechanically circulating the aquarium water through the matrix with a pump.

Optionally, aquatic or terrestrial plants also may be used to further reduce nutrient concentrations in the aquarium water. Plants reduce nutrient concentrations by taking up the nutrients through the plant roots and converting them to plant biomass. In addition, plant roots provide additional growing surface for nutrient-removing microbes. Finally, a symbiotic combination of plants and microbes takes up nutrients more efficiently than either plants or microbes working alone. Some of the harmful nutrients are converted to harmless gas and released to the atmosphere (for example, ammonia is converted sequentially to nitrite, nitrate, and nitrogen gas), and some of the harmful nutrients are converted into microbial and plant biomass, a portion of which may be used as a food source by the animal community living in the aquarium.

In a preferred embodiment, the present invention removes suspended solids from the water, thereby improving water clarity. Larger particles may be removed from the water via mechanical filtration, by pumping the water through the porous matrix material, whereby the particles become trapped within the matrix. Smaller colloidal-size particles (e.g., clay particles) typically have an electrical charge on their outer surface which attracts them to the fibers of the matrix. The cover may be periodically removed from the aquarium and rinsed in clean water in order to remove accumulated particles and restore the effectiveness of the filtration. When used in conjunction with a conventional aquarium filter, the cover in accordance with the present invention supplements the biological and mechanical filtering action of the conventional filter, thereby reducing the frequency of required cleaning of the conventional filter. In another preferred embodiment, the present invention provides an attractive exhibit of living plants that grow through the body of the cover, with stems that extend up from the top of the cover and roots that extend down into the aquarium water.

In a preferred embodiment, the invention is a cover for an aquarium having an opening comprising: a porous nonwoven matrix body having a top surface and a bottom surface and comprising fibers, said porous nonwoven matrix body being configured to substantially cover all or part of the opening and being capable of accommodating the growth of plants with roots that extend below said bottom surface; and a plurality of plants growing in said porous nonwoven matrix body.

Preferably, the cover further comprises: a plurality of buoyant foam units that have been injected into said nonwoven matrix to produce a buoyant mass; wherein said buoyant foam units are comprised of an expanded, cured polyurethane resin that envelopes a portion of said fibers to produce foamed zones. Preferably, said foamed zones are approximately spherical in shape. Preferably, said top surface is coated with a sprayed-on rigid polymer top coat. Preferably, said sprayed-on rigid polymer top coat is comprised of polyurethane, polyurea or silicone. Preferably, said top coat is underlain by a foam layer. Preferably, a water-based latex binder is baked onto the fibers.

In another preferred embodiment, the invention is a cover for an aquarium comprising: a first porous nonwoven matrix member that is configured to produce an outer wall section and a second porous nonwoven matrix member that is configured to produce a bottom section, said bottom section having a lower surface, said first porous nonwoven matrix member and said second porous nonwoven matrix member being attached to form a pocket; a plant growth medium disposed within said pocket to produce a bed having an upper surface; and a fish feeding port having one end that extends above said upper surface and another end that extends below said lower surface. Preferably, said bed and said bottom section are capable of accommodating the growth of plants with roots that extend below said bottom surface. Preferably, said fish feeding port comprises a tube. Preferably, said plant growth medium is selected from the group consisting of bedding soil, peat, hydrophilic foam and a combination of these materials.

In yet another preferred embodiment the invention is a method of covering an aquarium having an opening formed by its walls, said method comprising: providing a porous nonwoven matrix body having a top surface and a bottom surface and comprising fibers, said porous nonwoven matrix body being configured to substantially cover the opening and being capable of accommodating the growth of plants with roots that extend below said bottom surface; placing said porous nonwoven matrix body in the opening. Preferably, the method further comprises: securing said porous nonwoven matrix body in the opening by a friction fit, by use of conventional fastening means (such as brackets or clamps) or by supporting said porous nonwoven matrix body on legs. Preferably, the method further comprises: providing a porous nonwoven matrix body that is buoyant by injecting a closed cell polyurethane foam into said porous nonwoven matrix body. Preferably, the method further comprises: planting at least one plant in said porous nonwoven matrix body. Preferably, the method further comprises: providing a porous nonwoven matrix body through which a fish feeding port has been installed, said fish feeding port comprising a tube and a removable top cap for said tube. Preferably, the method further comprises: providing a porous nonwoven matrix body that comprises: a first porous nonwoven matrix member that is configured to produce an outer wall section and a second porous nonwoven matrix member that is configured to produce a bottom section, said bottom section having a lower surface, said first porous nonwoven matrix member and said second porous nonwoven matrix member being attached to form a pocket; a plant growth medium disposed within said pocket to produce a bed having an upper surface; and a fish feeding port having one end that extends above said upper surface and another end that extends below said lower surface. Preferably, the method further comprises: providing a porous nonwoven matrix body into which a tunnel or cave has been installed.

In a further preferred embodiment, the invention is a method of covering an aquarium having an opening formed by its walls, said method comprising: a step for providing a porous nonwoven matrix body having a top surface and a bottom surface and comprising fibers, said porous nonwoven matrix body being configured to substantially cover the opening and being capable of accommodating the growth of plants with roots that extend below said bottom surface; a step for placing said porous nonwoven matrix body in the opening.

In another preferred embodiment, the invention is a method of covering an aquarium having an opening, said method comprising: configuring a porous nonwoven matrix blanket to have a press fit with the opening; and pressing said nonwoven matrix blanket into the opening; wherein said porous nonwoven matrix blanket is comprised of polyester fibers that are intertwined to form a randomly oriented web and a water-based latex binder that has been baked onto said polyester fibers, thereby increasing the stiffness and durability of said blanket.

In yet another preferred embodiment, the invention is a method of covering an aquarium having an opening formed by its walls, said method comprising: providing a cover disclosed herein, said porous nonwoven matrix body being capable of accommodating the growth of plants with roots that extend below said bottom surface; placing said porous nonwoven matrix body in the opening.

In another preferred embodiment, the invention is a cover for an aquarium having an opening comprising: a porous nonwoven matrix body having a top surface and a bottom surface and comprising fibers, said porous nonwoven matrix body being configured to substantially cover the opening and being capable of accommodating the growth of plants with roots that extend below said bottom surface; and a plurality of plants growing in said porous nonwoven matrix body. Preferably, the cover further comprises a plurality of buoyant foam units that have been introduced into said nonwoven matrix to produce a buoyant mass, and each of said buoyant foam units is comprised of a buoyant foam material selected from the group consisting of: an expanded, cured thermosetting foam that envelopes a portion of said fibers to produce foamed zones; an expanded, cooled thermoplastic foam that envelopes a portion of said fibers to produce foamed zones; and a plurality of blocks of pre-cured foam inserted into precut holes in said nonwoven matrix or mechanically bonded within or onto the matrix.

Preferably, the cover further comprises an expanded multi-part polyurethane foam that has chemically cured around at least some of said fibers. Preferably, the cover further comprises an expanded polyethylene foam that has hardened around at least some of said fibers. Preferably, said nonwoven matrix has a plurality of precut holes and said cover further comprises a block of foam inserted into each of said precut holes. Preferably, the cover further comprises an accessory that is mounted on said top surface. Preferably, said fibers are selected from the group consisting of: polyester fibers, polyethylene fibers, and polypropylene fibers. Preferably, said nonwoven matrix includes a binder. Preferably, said binder is a baked-on latex adhesive.

In yet another preferred embodiment, the invention is a cover for an aquarium having an opening and containing water, said cover comprising: a nonwoven matrix body, said porous nonwoven matrix body being configured to substantially cover the opening and maintain position on the water and having a slot in it through which the water is accessible; an under layer applied to said nonwoven matrix body; a top coat applied to said under layer; and a fish feeder that is mounted on said top coat and that is communication with the water. Preferably, said fish feeder further comprises a rotatable hub, a plurality of arms that extend radially from said rotatable hub, each of which arms has an outer end, and a cup hung from each outer end. Preferably, each cup is capable of holding fish food and being rotated into the water.

In another preferred embodiment, the invention is a cover for an aquarium having an opening comprising: a porous nonwoven matrix body having a top surface, a bottom surface, a periphery and one or more holes disposed along its periphery and comprising fibers, said porous nonwoven matrix body being configured to substantially cover all or part the opening and being capable of accommodating the growth of plants with roots that extend below said bottom surface; and a leg that is insertable in each said hole in said porous nonwoven matrix body. Preferably, said holes and legs are sized so as to produce a friction fit of each said leg in each said hole. Preferably, each said leg is comprised of a first length of plastic pipe or a second length of plastic rod.

In yet another preferred embodiment, the invention is a cover for an aquarium having an opening comprising: a porous nonwoven matrix body having a top surface and a bottom surface and comprising fibers, said porous nonwoven matrix body being configured to substantially cover all or part of the opening and being capable of accommodating the growth of plants with roots that extend below said bottom surface.

In yet another preferred embodiment the invention is a cover for an aquarium having an opening and containing water, said cover comprising: a nonwoven matrix body, said porous nonwoven matrix body being configured to substantially cover the opening and maintain position on the water and having a slot in it through which the water is accessible.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the concept. Thus, the following drawings and description are to be regarded as illustrative in nature and not restrictive.

### BRIEF DESCRIPTION OF THE SEVERAL VIEWS OF THE DRAWINGS

The features of the invention will be better understood by reference to the accompanying drawings which illustrate presently preferred embodiments of the invention.

FIG. 1 is an exploded perspective view of an aquarium equipped with a first preferred embodiment of the present invention.

FIG. 2 is a perspective view of a second preferred embodiment of the present invention, in which a pocket is provided for growing plants.

FIG. 3 is an elevation (side) view of an aquarium with an aquarium cover installed in accordance with another preferred embodiment of the invention.

FIG. 4 is a schematic cross-sectional view of a third preferred embodiment of the invention that comprises a rigid top cover and a fish-activated fish feeder that is configured to simulate a miniature Ferris wheel.

FIG. 5 is an exploded perspective view of a fourth preferred embodiment of the present invention, in which the matrix is supported by legs.

The following reference numerals are used to indicate the parts and environment of the invention on the drawings:
1 aquarium
2 aquarium cover
3 nonwoven matrix body, matrix
4 plants
5 plant roots
6 outer wall section
7 bottom section
8 fish feeding port
9 fish
10 growth medium
11 pocket
12 plastic tube
13 top cap
14 top surface
15 side surface
16 bottom surface
17 polyurethane under layer, under layer
18 polyurea top coat, top coat
19 fish feeder
20 fish food cup
22 legs

### DETAILED DESCRIPTION OF THE INVENTION

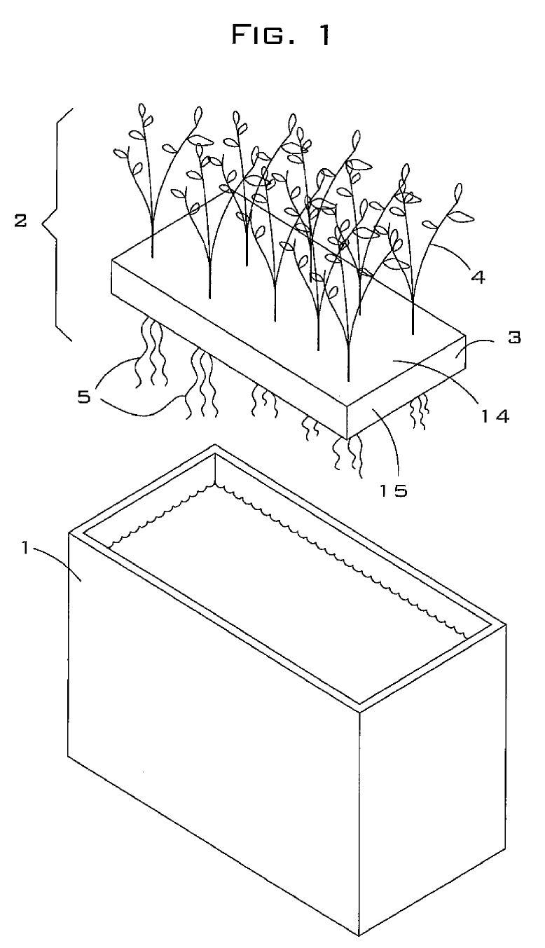

Referring to FIG. 1, aquarium 1 is equipped with a first preferred embodiment of the present invention. In this embodiment, aquarium cover 2 comprises nonwoven matrix body 3, plants 4 and plant roots 5. Preferably, the nonwoven matrix body 3 is a uniform block of nonwoven polyester fibers that is both porous and permeable, and is able to be penetrated by plant roots. The fibers preferably provide a large surface area for colonization by natural and/or introduced microbes that are able to take up and convert harmful nutrients such as ammonia, nitrate, and phosphorus.

In a preferred embodiment, matrix 3 is comprised of polyester, polyethylene, or polypropylene fibers that are intertwined to form a randomly oriented web or “blanket” with a standard thickness and width. While small aquarium covers may be made of a single piece and thickness of matrix, the dimensions of a larger covers are preferably set by attaching multiple pieces of matrix side-by-side and vertically. In one preferred embodiment, the matrix is comprised of 200-denier polyester fibers that are intertwined to form a blanket approximately 1 ¾ inch thick by 56 inches wide as it comes off the production line.

Cover 2 is preferably cut from the matrix stock to form a close fit within the inner walls of aquarium 1, thereby covering the opening formed by the inner walls. The nominal weight of the blanket is preferably 41 ounces per square yard. The nominal weight of the polyester fibers within the blanket is preferably 26 ounces per square yard. A water-based latex binder is preferably baked onto the fibers to increase the stiffness and durability of the blanket.

In a preferred embodiment, the characteristics of matrix 3 are adjusted by varying the construction materials and manufacturing process. For example, the diameter of the fibers may be varied from approximately 6 to 300 denier. Coarse fibers result in a relatively stiff matrix with relatively small surface area for colonizing microbes, and fine fibers result in a relatively flexible matrix with a relatively large surface area for colonizing microbes. The latex binder can be applied relatively lightly or relatively heavily to vary the durability and weight of the matrix, and dye or pigment can be added to the binder to produce a specific color of matrix. The thickness of the blanket can be adjusted from approximately ¼-inch to 2 inches using preferred manufacturing techniques. The applicants anticipate that when thicker blankets are produced in the future, these thicker blankets (for example 3 to 12 inches) will be used for aquarium covers. The blankets with integral latex binder may be purchased as a manufactured item. One manufacturer of suitable matrix material is Americo Manufacturing Company, Inc. of Acworth, Ga.

Optionally, internal buoyancy may be integrated into matrix 3 by injecting uncured liquid polyurethane resin under pressure into the porous matrix. The polyurethane resin then expands and cures in place within the matrix. The injection pressure, resin temperature, and injection shot volume of the foam injection machine are preset so as to provide the desired final volume of cured buoyant foam. The foam may be installed so as to provide a continuous volume throughout the matrix, or alternately, it may be installed so as to provide individual buoyant sections of foam within the matrix that are separated by non-foamed zones of matrix. The polyurethane resin may be injected from top surface 14, side surface 15, or bottom surface 16 (shown in FIG. 3) of the matrix, or from a combination of these surfaces, depending on the particular application of cover 2. Alternately, thermosetting foam such as polyethylene foam may be used instead of polyurethane foam to provide optional buoyancy. The polyethylene foam is extruded into the matrix along with an expansion gas, after which it expands, cools and hardens around the matrix fibers. Buoyancy may also be provided by blocks of pre-cured foam (not shown) that are inserted into precut holes within the matrix or mechanically bonded within or onto the matrix.

In a preferred embodiment, matrix 3 is constructed so as to have a thickness of approximately 1.75 inches. Uncured foam resin having a nominal cured density of 2.5 pounds per cubic foot (pcf) is preferably injected into bottom surface 16 of matrix 3, and penetrates to top surface 14 of the matrix. A 0.5-second shot of uncured foam is preferably injected with a pressure of approximately 70 pounds per square inch, resulting in a cured mass of foam approximately spherical in shape, having a diameter of approximately 2 inches. The sphere has a density of approximately 5.8 pcf, consisting of approximately 2.5 pcf polyurethane foam that is reinforced with matrix having a density of approximately 3.3 pcf. The density of the polyurethane foam may be adjusted by varying the chemical formula of the resin, or by varying the application parameters such as temperature and pressure. Practical ranges of foams for the covers range from about 1.0 to 25.0 pcf.

A portion or the entire top surface of cover 2 may optionally be coated with a rigid spray-on polymer top coat (not shown). The top coat may be used to increase durability of the product, to provide a rest area for non-aquatic animals, or for decorative purposes. Top coatings may be comprised of any durable spray-applied polymer such as polyurethane, polyurea, or silicone. The spray coatings are preferably underlain with a relatively thin layer of polyurethane foam. A preferred thickness for the foam under layer is approximately ½-inch. A preferred range of thickness for the top coat is approximately 0.005 to 0.25 inches.

In one preferred embodiment, a rigid top coat is constructed across the top surface of aquarium cover 2 by first spraying on a rapid setting, two-part polyurethane resin that cures into a foam layer that extends approximately ½-inch into the top surface of nonwoven matrix 3. The second step consists of spraying on a two-part polyurea resin that cures in place on top of the foam layer to form a ⅛-inch thick rigid and durable top coat. Dye or pigment may be added to the top coat to provide the desired color and to increase the ultraviolet light (UV) resistance of the material and the underlying foam.

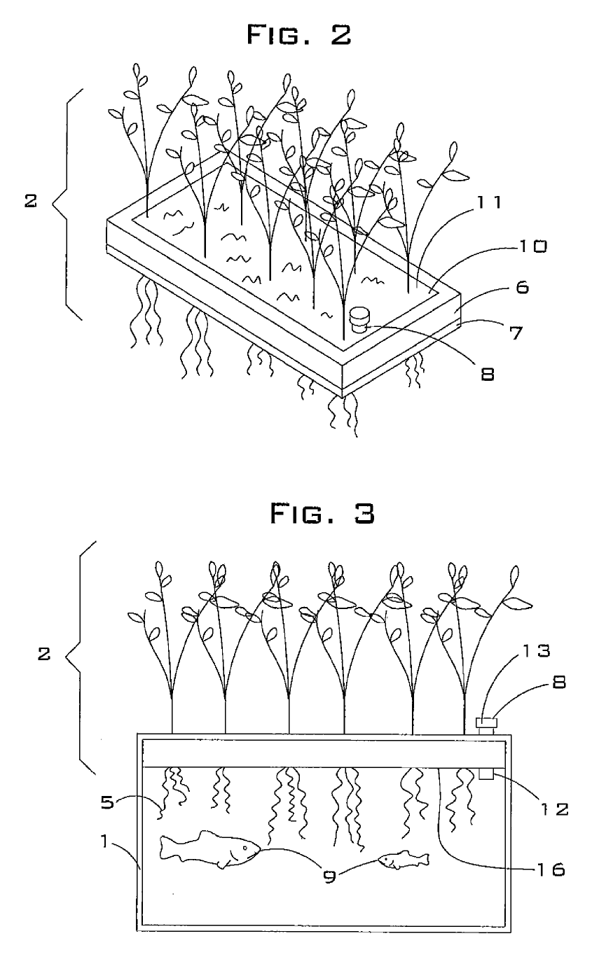

Referring to FIG. 2, a second preferred embodiment of the present invention is presented, in which pocket 11 is provided for growing plants. In this embodiment, aquarium cover 2 is comprised of outer wall section 6, bottom section 7, fish feeding port 8 and growth medium 10 in pocket 11. Fish feeding port 8 is comprised of plastic tube 12 with removable top cap 13 (see FIG. 3). Plastic tube 12 penetrates matrix and allows fish food (not shown) to be dropped to fish 9 without removing the cover.

Outer wall section 6 and bottom section 7 are preferably manufactured from nonwoven polyester fiber, that is, from the same material from which matrix 3 (see FIG. 1) is constructed. The dimensions of pocket 11 are dependent on the cover size; for example, a cover made for a 50-gallon aquarium would preferably have 1-inch thick outer walls (forming outer wall section 6) and a 1¾-inch thick bottom (forming bottom section 7). Growth medium 10 may be comprised of any suitable material or mixture of materials, such as bedding soil, peat, and/or hydrophilic foam.

Both of the above disclosed embodiments are designed to be positioned near the top of aquarium 1 so that a portion of cover body 3 or wall section 6 is submerged, and a portion is above waterline. Aquarium cover 2 may be secured in the proper position by a friction fit, or by conventional fastening means such as metal or plastic clips that fasten over the top edge of the sides of the tank. Alternately, cover 2 may be manufactured so as to be buoyant, thereby causing it to float in the proper partly-submerged position. The preferred means of achieving buoyancy is to inject a closed cell polyurethane foam into matrix body 3 for the first embodiment, or into the matrix outer section 6 and bottom section 7 for the second embodiment. When cover 2 is manufactured so as to be buoyant, it may be referred to as a “floating island” cover.

Referring to FIG. 3, aquarium 1 is shown with aquarium cover 2 installed in accordance with the preferred embodiments of the invention of FIGS. 1 and 2. Thus, this drawing presents a side view both the first and second embodiments of the invention. As shown, aquatic plant roots 5 extend into the water, where they are able to take up nutrients, be colonized by microbes, and serve as a food source for aquarium animals, such as fish 9. Fish feeding tube 8 is also shown because fish feeding tube 8 may be incorporated into any embodiment of cover 2.

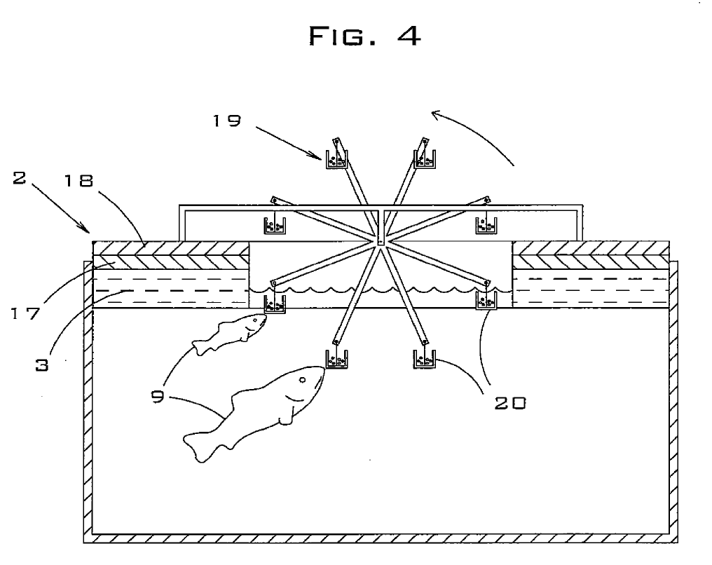

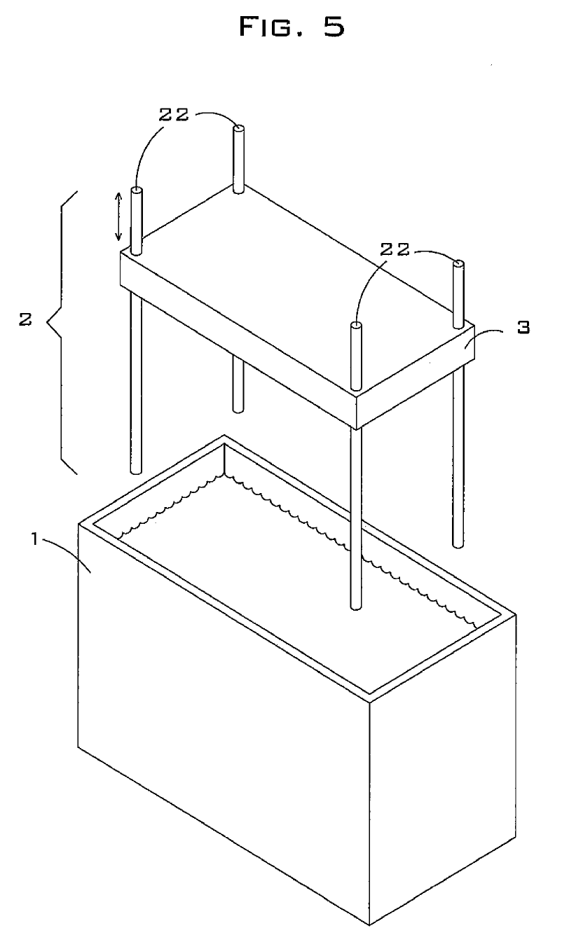

FIG. 4 is a schematic illustration of a third preferred embodiment of the invention. This embodiment comprises a rigid top cover and a fish-activated fish feeder that is shaped to simulate a miniature Ferris wheel. In this embodiment, aquarium cover 2 is comprised of nonwoven matrix body 3, polyurethane foam under coat 17, and polyurea top coat 18. Fish feeder 19 is mounted on top coat 18. Each arm of fish feeder 19 is attached to a food cup 20. The cups are periodically filled with fish food by the owner. Fish feeder 19 is mounted so that the arms may extend through a slot in cover 2 into the aquarium water as the fish feeder rotates in the direction shown by the arrow. The power to rotate fish feeder 19 is supplied by fish 9, which learn to push the arms of feeder 19 so as to rotate the device, thereby bringing feed-filled cups into the water where they are available to the fish. The fish feeder provides entertainment to the owner, and can also serve as means of supplying food to the fish over an extended period of time, thereby eliminating the need to manually feed the fish on a daily basis.

A fourth embodiment of the aquarium cover preferably comprises stiff legs that support the aquarium cover within the aquarium. An exploded perspective view of an aquarium cover with legs is shown in FIG. 5. As shown in FIG. 5, cover 2 is comprised of matrix body 3, which is supported on legs 22. Legs 22 preferably penetrate matrix body 3 via vertical holes (not shown) that are cut though matrix body 3 near each corner of matrix body 3. The holes are preferably cut so as to be slightly undersized, thereby producing a relatively tight friction fit between each leg 22 and the hole into which it is inserted. The friction is preferably sufficient to hold the legs in place during normal use of the aquarium cover but loose enough so that each leg may be adjusted up or down as shown by the arrow, thereby providing a means of adjusting the vertical position of the matrix body 3 within aquarium 1. Legs 22 may be constructed of any suitably stiff and non-reactive material such as polypropylene or polyethylene pipe. Legs 22 may be either hollow or solid.

The embodiment shown in FIG. 5 may have advantages for certain applications; for example, the matrix body may be set relatively deep in the aquarium water to provide ideal growing conditions for aquatic plants, or set relatively shallow to provide ideal growing conditions for non-aquatic plants. Another advantage of this embodiment is that the aquarium cover can be set at an optimum height regardless of the water level in the aquarium. For example, the aquarium may be half-filled to exhibit small fish in the water and tall plants growing on the cover, or the aquarium may be completely filled to exhibit large fish and small plants. The height of the cover may be adjusted to provide optimum operation under each of these conditions. Another advantage of this embodiment is that the cover is not required to be buoyant because the weight of the cover is supported by the legs, thereby eliminating the need for buoyant foam. Eliminating the buoyant foam component may provide a cost savings in both materials and labor, thereby making the cover more appealing as a commercial product.

In other preferred embodiments, features like tunnels and caves are installed into the matrix in order to provide habitat for animals. These features may be installed by drilling with hole saws, punching out with dies, or by melting with hot-wire cutters. When using toothed saws and cutters to cut the matrix, the teeth tend to grab the matrix fibers and stretch them, rather than cutting cleanly. To minimize this problem, it is advantageous to remove the teeth and replace with a knife edge. Alternately, circular saws may be run in reverse to minimize tooth binding. With such features, animals such as crayfish can use the underside of the cover as an upside-down perch, creating an interesting view.

The planting portion of the cover may be used to grow plants at least three ways, including saturated-zone plant growth, capillary-supplied vadose-zone growth, and conventionally watered growth. The constant moisture condition that is maintained in the bi-vadose zone is ideal for riparian plants, which cannot tolerate periods of dryness.

### WORKING EXAMPLE

The present invention has been shown to remove suspended solids from water in an aquarium, thereby improving water clarity. In two experiments involving aquariums with fine-grained bottom soil and aquatic animals, water clarity in 50-gallon aquariums was measured with a 2-inch diameter Secchi Disk. In the first experiment, an aquarium with no cover had a water visibility of 14 centimeters (cm) or less for a period of 20 days. Seven days after an aquarium cover was installed, visibility exceeded the maximum reading of the measuring device (120 cm). In the second experiment, an aquarium with no cover had a water visibility of 5 cm or less for a period of 46 days. Seven days after an aquarium cover was installed, the visibility increased to 52 cm.

Many variations of the invention will occur to those skilled in the art. Some variations include a single matrix blanket. Other variations call for side and bottom sections that form a pocket for holding a planting mix. Yet other variations call for the matrix body to cover all or part of the aquarium opening. All such variations are intended to be within the scope and spirit of the invention.

Although some embodiments are shown to include certain features, the applicant(s) specifically contemplate that any feature disclosed herein may be used together or in combination with any other feature on any embodiment of the invention. It is also contemplated that any feature may be specifically excluded from any embodiment of the invention.

What is claimed is:

1. A cover for an aquarium having an opening comprising:
a porous nonwoven matrix body having a top surface and a bottom surface and comprising fibers, said porous nonwoven matrix body being configured to substantially cover all or part of the opening and being capable of accommodating the growth of plants with roots that extend below said bottom surface; and
a plurality of plants growing in said porous nonwoven matrix body.

2. The cover of claim 1 further comprising:
a plurality of buoyant foam units that have been injected into said nonwoven matrix to produce a buoyant mass;
wherein said buoyant foam units are comprised of an expanded, cured polyurethane resin that envelopes a portion of said fibers to produce foamed zones.

3. The cover of claim 2 wherein said foamed zones are approximately spherical in shape.

4. The cover of claim 2 wherein said top surface is coated with a sprayed-on rigid polymer top coat.

5. The cover of claim 4 further wherein said sprayed-on rigid polymer top coat is comprised of polyurethane, polyurea or silicone.

6. The cover of claim 5 wherein said top coat is underlain by a foam layer.

7. The cover of claim 1 wherein a water-based latex binder is baked onto the fibers.

8. A cover for an aquarium comprising:
a first porous nonwoven matrix member that is configured to produce an outer wall section and a second porous nonwoven matrix member that is configured to produce a bottom section, said bottom section having a lower surface, said first porous nonwoven matrix member and said second porous nonwoven matrix member being attached to form a pocket;
a plant growth medium disposed within said pocket to produce a bed having an upper surface; and
a fish feeding port having one end that extends above said upper surface and another end that extends below said lower surface.

9. The cover of claim 8 wherein said bed and said bottom section are capable of accommodating the growth of plants with roots that extend below said bottom surface.

10. The cover of claim 8 wherein said fish feeding port comprises a tube and a removable top cap for said tube.

11. The cover of claim 8 wherein said plant growth medium is selected from the group consisting of bedding soil, peat, hydrophilic foam and a combination of these materials.

12. A method of covering an aquarium having an opening formed by its walls, said method comprising:
providing a porous nonwoven matrix body having a top surface and a bottom surface and comprising fibers, said porous nonwoven matrix body being configured to substantially cover the opening and being capable of accommodating the growth of plants with roots that extend below said bottom surface;
placing said porous nonwoven matrix body in the opening.

13. The method of claim 12 further comprising:
securing said porous nonwoven matrix body in the opening by a friction fit by use of conventional fastening means or by supporting said porous nonwoven matrix body on legs.

14. The method of claim 12 further comprising:
providing a porous nonwoven matrix body that is buoyant by injecting a closed cell polyurethane foam into said porous nonwoven matrix body.

15. The method of claim 12 further comprising:
planting at least one plant in said porous nonwoven matrix body.

16. The method of claim 12 further comprising:
providing a porous nonwoven matrix body through which a fish feeding port has been installed, said fish feeding port comprising a tube.

17. The method of claim 12 further comprising:
providing a porous nonwoven matrix body that comprises:
a first porous nonwoven matrix member that is configured to produce an outer wall section and a second porous nonwoven matrix member that is configured to produce a bottom section, said bottom section having a lower surface, said first porous nonwoven matrix member and said second porous nonwoven matrix member being attached to form a pocket;
a plant growth medium disposed within said pocket to produce a bed having an upper surface; and
a fish feeding port having one end that extends above said upper surface and another end that extends below said lower surface.

18. The method of claim 12 further comprising:
providing a porous nonwoven matrix body into which a tunnel or cave has been installed.

19. A method of covering an aquarium having an opening formed by its walls, said method comprising:
a step for providing a porous nonwoven matrix body having a top surface and a bottom surface and comprising fibers, said porous nonwoven matrix body being configured to substantially cover the opening and being capable of accommodating the growth of plants with roots that extend below said bottom surface;
a step for placing said porous nonwoven matrix body in the opening.

20. A method of covering an aquarium having an opening, said method comprising:
configuring a porous nonwoven matrix blanket to have a press fit with the opening; and
pressing said nonwoven matrix blanket into the opening;
wherein said porous nonwoven matrix blanket is comprised of polyester fibers that are intertwined to form a randomly oriented web and a water-based latex binder that has been baked onto said polyester fibers, thereby increasing the stiffness and durability of said blanket.

21. A method of covering an aquarium having an opening formed by its walls, said method comprising:
providing the cover of claim 1, said porous nonwoven matrix body being capable of accommodating the growth of plants with roots that extend below said bottom surface;
placing said porous nonwoven matrix body in the opening.

22. A method of covering an aquarium having an opening formed by its walls, said method comprising:
providing the cover of claim 8, said porous nonwoven matrix body being capable of accommodating the growth of plants with roots that extend below said lower surface;
placing said porous nonwoven matrix body in the opening.

23. A cover for an aquarium having an opening comprising:
a porous nonwoven matrix body having a top surface and a bottom surface and comprising fibers, said porous nonwoven matrix body being configured to substantially cover the opening and being capable of accommodating the growth of plants with roots that extend below said bottom surface; and
a plurality of plants growing in said porous nonwoven matrix body.

24. The cover of claim 23 further comprising:
a plurality of buoyant foam units that have been introduced into said nonwoven matrix to produce a buoyant mass;
wherein each of said buoyant foam units is comprised of a buoyant foam material selected from the group consisting of:
an expanded, cured thermosetting foam that envelopes a portion of said fibers to produce foamed zones,
an expanded, cooled thermoplastic foam that envelopes a portion of said fibers to produce foamed zones, and
a plurality of blocks of pre-cured foam inserted into precut holes in said nonwoven matrix or mechanically bonded within or onto the matrix.

25. The cover of claim 23 further comprising:
an expanded multi-part polyurethane foam that has chemically cured around at least some of said fibers.

26. The cover of claim 23 further comprising:
an expanded polyethylene foam that has hardened around at least some of said fibers.

27. The cover of claim 23 wherein said nonwoven matrix has a plurality of precut holes and said cover further comprises:
a block of foam inserted into each of said precut holes.

28. The cover of claim 23 further comprising:
an accessory that is mounted on said top surface.

29. The cover of claim 23 wherein said fibers are selected from the group consisting of:
polyester fibers,
polyethylene fibers, and
polypropylene fibers.

30. The cover of claim 23 wherein said nonwoven matrix includes a binder.

31. The cover of claim 30 wherein said binder is a baked-on latex adhesive.

32. A cover for an aquarium having an opening and containing water, said cover comprising:
a nonwoven matrix body, said porous nonwoven matrix body being configured to substantially cover the opening and maintain position on the water and having a slot in it through which the water is accessible;
an under layer applied to said nonwoven matrix body;
a top coat applied to said under layer; and
a fish feeder that is mounted on said top coat and that is communication with the water.

33. The cover of claim 32 wherein said fish feeder further comprises a rotatable hub, a plurality of arms that extend radially from said rotatable hub, each of which arms has an outer end, and a cup hung from each outer end.

34. The cover of claim 33 wherein each cup is capable of holding fish food and being rotated into the water.

35. A cover for an aquarium having an opening comprising:
a porous nonwoven matrix body having a top surface, a bottom surface, a periphery and one or more holes disposed along its periphery and comprising fibers, said porous nonwoven matrix body being configured to substantially cover all or part of the opening and being capable of accommodating the growth of plants with roots that extend below said bottom surface; and
a leg that is insertable in each said hole in said porous nonwoven matrix body.

36. The cover of claim 35 wherein said holes and legs are sized so as to produce a friction fit of each said leg in each said hole.

37. The cover of claim 35 wherein each said leg is comprised of a first length of plastic pipe or a second length of plastic rod.

38. A cover for an aquarium having an opening comprising:
a porous nonwoven matrix body having a top surface and a bottom surface and comprising fibers, said porous nonwoven matrix body being configured to substantially cover all or part of the opening and being capable of accommodating the growth of plants with roots that extend below said bottom surface.

39. A cover for an aquarium having an opening and containing water, said cover comprising:
a nonwoven matrix body, said porous nonwoven matrix body being configured to substantially cover the opening and maintain position on the water and having a slot in it through which the water is accessible.
